(19) United States
(12) Patent Application Publication
(10) Pub. No.: US 2026/0056639 A1
(43) Pub. Date: Feb. 26, 2026

(54) METHOD, APPARATUS, DEVICE AND STORAGE MEDIUM FOR INTERFACE INTERACTION

(71) Applicant: Beijing Zitiao Network Technology Co., Ltd., Beijing (CN)

(72) Inventors: Songyu Wang, Beijing (CN); Siran Liao, Beijing (CN); Weiwei Xue, Beijing (CN)

(21) Appl. No.: 19/310,712

(22) Filed: Aug. 26, 2025

(30) Foreign Application Priority Data
Aug. 26, 2024 (WO) PCT/CN2024/114571

(51) Int. Cl. G06F 3/0481; G06F 3/0484

(52) U.S. Cl. CPC G06F 3/0481; G06F 3/0484

(57) ABSTRACT

Embodiments of the disclosure relate to methods, apparatuses, devices, and storage media for interface interaction. The method includes: presenting a plurality of media components in a target style in a target interface, the target style indicating a layout of at least a portion of the plurality of media components in a plurality of columns or rows; triggering a first media component in the plurality of media components to play corresponding first media content; in response to a slide on the target interface, adjusting display positions of the plurality of media components in the target interface; and in response to a first display position of a second media component in the plurality of media components adjusted to satisfy a first trigger condition, triggering the second media component to play corresponding second media content, wherein the first trigger condition corresponds to a column or row where the second media component is located.

### CROSS-REFERENCE

The present application claims priority to International Patent Application No. PCT/CN2024/114571, filed on Aug. 26, 2024 and entitled “METHOD, APPARATUS, DEVICE, AND STORAGE MEDIUM FOR INTERFACE INTERACTION”, the entirety of which is incorporated herein by reference.

### FIELD

Example embodiments of the present disclosure generally relate to the field of computers, and in particular, to a method, an apparatus, a device, and a computer-readable storage medium for interface interaction.

### BACKGROUND

In recent years, with the development of the Internet, more and more users view media content on a network platform. In order to meet the user's viewing requirements and improve the showing efficiency of the media content, the network platform tends to present multiple media content in the same interface. However, the playing mechanisms provided by the network platform for the presented media content cannot meet the requirements of users.

### SUMMARY

In a first aspect of the present disclosure, a method for interface interaction is provided, including: presenting a plurality of media components in a target style in a target interface, the target style indicating a layout of at least a portion of the plurality of media components in a plurality of columns or rows; triggering a first media component in the plurality of media components to play corresponding first media content; in response to a sliding operation for the target interface, adjusting display positions of the plurality of media components in the target interface; and in response to a first display position of a second media component in the plurality of media components adjusted to satisfy a first trigger condition, triggering the second media component to play corresponding second media content, wherein the first trigger condition corresponds to a column or row where the second media component is located, and different columns or rows correspond to different trigger conditions.

In a second aspect of the present disclosure, an apparatus for interface interaction is provided. The apparatus includes: a presentation module configured to present a plurality of media components in a target style in a target interface, the target style indicating a layout of at least a portion of the plurality of media components in a plurality of columns or rows; a first trigger module configured to trigger a first media component in the plurality of media components to play corresponding first media content; an adjustment module configured to, in response to a sliding operation for the target interface, adjust display positions of the plurality of media components in the target interface; and a second trigger module configured to, in response to a first display position of a second media component in the plurality of media components adjusted to satisfy a first trigger condition, trigger the second media component to play corresponding second media content, where the first trigger condition corresponds to a column or row in which the second media component is located, and different columns or rows correspond to different trigger conditions.

In a third aspect of the present disclosure, an electronic device is provided. The electronic device includes at least one processor; and at least one memory coupled to the at least one processor and storing instructions for execution by the at least one processor. The instructions, when executed by the at least one processor, cause the electronic device to perform the method of the first aspect.

In a fourth aspect of the present disclosure, a computer-readable storage medium is provided. The computer-readable storage medium stores a computer program, and the computer program is executable by the processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, in which:

FIG. 1 illustrates a schematic diagram of an example environment in which embodiments of the present disclosure can be implemented;

FIGS. 2A-2E illustrate example interfaces according to some embodiments of the present disclosure;

FIGS. 3A-3B illustrate example interfaces according to some embodiments of the present disclosure;

FIG. 4 shows a flowchart of an example process for interface interaction according to some embodiments of the present disclosure;

FIG. 5 illustrates a schematic structural block diagram of an example apparatus for interface interaction according to some embodiments of the present disclosure; and

FIG. 6 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the title of any section/subsection provided herein is not limiting. Various embodiments are described throughout this document and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “comprising” and the like should be understood to include “comprising but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow the corresponding laws and regulations and related regulations. In the embodiments of the present disclosure, all data collection, acquisition, handing, processing, forwarding, use, etc., all of which are performed on the premise of the user's knowledge and confirmations. Accordingly, when implementing the embodiments of the present disclosure, the types of the data or information that may be involved, the usage scope, the usage scenario, and the like should be notified to the user and the authorization of the user shall be obtained in an appropriate manner according to the relevant laws and regulations. The specific notification and/or authorization manner may vary according to actual situations and application scenarios, and the scope of the present disclosure is not limited in this respect.

According to the solutions in the present specification and the embodiments, if, for example, personal information processing is involved, processing may be performed on the premise of a legality basis (for example, obtaining consent of a personal information subject, or it is necessary for fulfillment of a contract), and processing will be carried out only within a specified or agreed range. The user may reject personal information other than necessary information required by the basic function, which will not affect the basic function of the user.

As briefly mentioned above, with the development of the Internet, more and more users view media content on a network platform. In order to meet the user's viewing requirements and improve the showing efficiency of the media content, the network platform tends to present multiple media content in the same interface. For example, multiple media content is presented in multiple rows or multiple columns. While presenting the plurality of media content, the network platform needs to play the corresponding media content to meet the viewing requirements of the user. However, when the network platform plays the presented multiple media content, the playing mechanism is too single (for example, only one side off the media content can be triggered to be played), which cannot meet the user's needs.

Embodiments of the present disclosure provide a solution for interface interaction. According to the solution, a plurality of media components may be presented in a target style in a target interface, the target style indicating a layout of at least a portion of the plurality of media components in a plurality of columns or rows; a first media component of the plurality of media components is triggered to play corresponding first media content; in response to a sliding operation for the target interface, a display position of the plurality of media components in the target interface is adjusted; and in response to a first display position of a second media component of the plurality of media components adjusted to satisfy a first trigger condition, the second media component is triggered to play corresponding second media content, wherein the first trigger condition corresponds to a column or row where the second media component is located, and different columns or rows correspond to different trigger conditions.

In this way, the embodiments of the present disclosure may adjust the position of the media component based on the sliding operation of the user, and may determine, according to the position of the media component, whether the trigger condition corresponding to the row or column where the media component is located is satisfied, to trigger the corresponding play component to play the corresponding media content. Therefore, the embodiment of the invention can dynamically switch preview of the media content in the interface according to the display position of the media component in the display interface of the multiple media content, so that the display efficiency of the media content is improved.

Various example implementations of this scheme are described in detail below in conjunction with the accompanying drawings.

### Example Environment

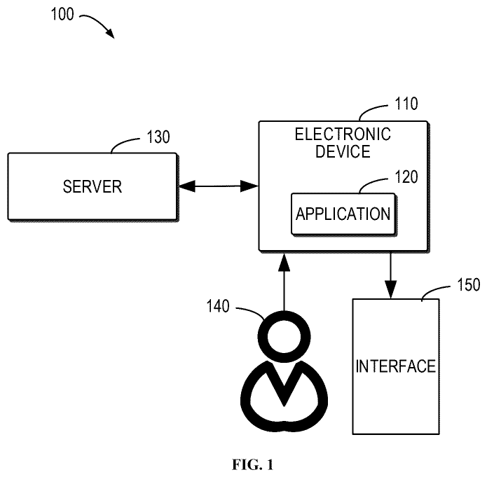

FIG. 1 illustrates a schematic diagram of an example environment 100 in which embodiments of the present disclosure can be implemented. As shown in FIG. 1, the example environment 100 may include an electronic device 110.

In this example environment 100, the electronic device 110 may run an application 120 that supports interface interaction. The application 120 may be any suitable type of application for interface interaction, examples of which may include, but are not limited to: a video application, a social application, or other suitable application. The user 140 may interact with the application 120 via the electronic device 110 and/or its attachment device.

In the environment 100 of FIG. 1, if the application 120 is active, the electronic device 110 may present, via the application 120, an interface 150 for supporting interface interaction.

In some embodiments, the electronic device 110 communicates with the server 130 to enable provision of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 can also support any type of interface for a user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for applications 120 that support virtual scenes in the electronic device 110.

A communication connection may be established between the server 130 and the electronic device 110. The communication connection may be established in a wired manner or a wireless manner. The communication connection may include, but is not limited to, a Bluetooth connection mobile network connection, a Universal Serial Bus (USB) connection, a Wireless Fidelity (WiFi) connection, and the like, and the embodiments of the present disclosure are not limited in this aspect. In an embodiment of the present disclosure, the server 130 and the electronic device 110 may implement signaling interaction through a communication connection between the server 130 and the electronic device 110.

It should be understood that the structures and functions of the various elements in the environment 100 are described for exemplary purposes only and do not imply any limitation to the scope of the present disclosure.

Some example embodiments of the present disclosure will be described below with continued reference to the accompanying drawings.

### Interface Interaction

### Example One

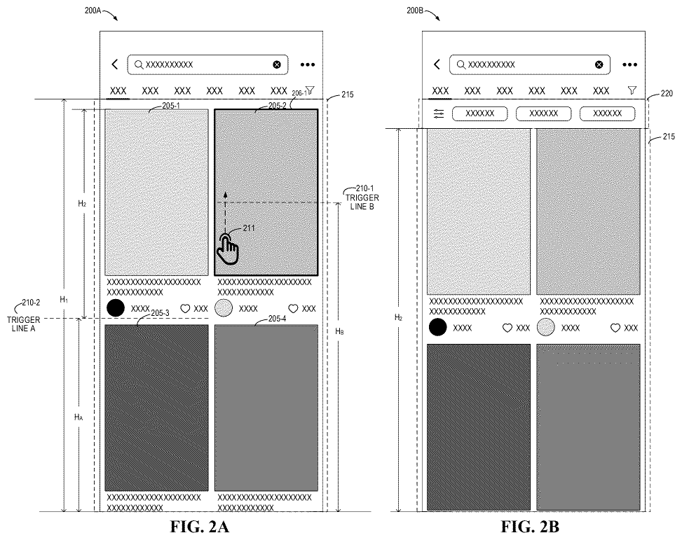

FIGS. 2A-2E illustrate example interfaces 200A-200E in accordance with some embodiments of the present disclosure. The interface 200A to the interface 200E may be provided, for example, by the electronic device 110 shown in FIG. 1.

In some embodiments, as shown in FIG. 2A, the electronic device 110 may present the target interface 200A. The electronic device 110 may present multiple media components in the target interface 200A. For example, the plurality of media components may include a media component 205-1, a media component 205-2, a media component 205-3, a media component 205-4, and/or the like. As an example, a media component may be used to play media content. As an example, the media content may include, for example, music content, graphics and text content, video content, and the like.

In some embodiments, with continued reference to FIG. 2A, the electronic device 110 may present the plurality of media components in the target style. The target style indicates a layout of at least a portion of the plurality of media components in multiple rows or columns.

In some embodiments, with continued reference to FIG. 2A, the electronic device 110 triggers a first media component of the plurality of media components to play the corresponding first media content. As an example, the electronic device 110 may trigger the first media content corresponding to the first media component (e.g., the media component 205-1).

In some embodiments, with continued reference to FIG. 2A, the electronic device 110 may determine the first media component based on rank of the plurality of media components in the target interface, in response to the target interface 200A being triggered to be presented. As an example, the rank of the plurality of media components in the target interface may be arranged in a zig-zag order (e.g., in a left-to-right order within the same row, in a top-to-bottom order between rows). For example, the media component 205-1 and the media component 205-2 in the first row may correspond to a first order and a second order, respectively. The media component 205-3 and the media component 205-4 in the second row may correspond to the third order and the fourth order, respectively. As an example, the electronic device 110 may determine the top-ranked media component as the first media component (e.g., the media component 205-1 in the first order) based on the rank of the multiple media components in the target interface.

In some embodiments, with continued reference to FIG. 2A, the electronic device 110 may provide a component interaction region 215 (also referred to as a sliding region 215) in the target interface. The electronic device 110 may present multiple media components in the component interaction region 215. Further, the electronic device 110 may receive a sliding operation from the user in the component interaction region 215.

In some embodiments, with continued reference to FIG. 2A, the region size of the component interaction region 215 may include a region height and a region width. The region height may, for example, be referred to as a region length. The region height may be, for example, H₁. The region height may indicate a sliding distance limit in a first direction (e.g., the direction indicated by operation 211). The region width may indicate a sliding distance limit in a direction perpendicular to the first direction.

In some embodiments, with continued reference to FIG. 2A, the electronic device 110 may determine the updated region size of the component interaction region 215 in response to a change in the layout of the target interface 200A.

In some embodiments, the change in the layout of the target interface 200A may include displaying an additional content region in the target interface 200A.

In some embodiments, as shown in FIG. 2B, the electronic device 110 may determine the updated region size of the component interaction region 215 in response to the additional content region being displayed in the target interface 200B. As an example, the electronic device 110 may determine the updated region size of the component interaction region 215 (e.g., the region height is updated to H₂ from H₁) in response to a set of screening components 220 being displayed in the target interface 200B. As an example, displaying the additional content region in the target interface 200B may be triggered based on user operation (e.g., clicking on a control associated with an additional content region, etc.), or may be automatically triggered (e.g., timed display, etc.) in the interface based on predetermined logic.

In some embodiments, the change in the layout of the target interface 200A may include stopping displaying an existing content region in the target interface 200A.

In some embodiments, with continued reference to FIG. 2A, the electronic device 110 may determine the updated region size of the component interaction region 215 in response to display of an existing content region in the target interface 200A being stopped. As an example, the electronic device 110 may determine the updated region size of the component interaction region 215 (e.g., the region height is updated from H₂ to H₁) in response to display of a set of screening components 220 in the target interface 200A being stopped. As an example, stopping displaying the existing content region in the target interface 200B may be triggered based on a user operation (e.g., clicking on a control associated with an additional content region, etc.), or may be automatically triggered in the interface based on predetermined logic (e.g., timed stop display, etc.).

As an example, displaying and stopping displaying the aforementioned set of screening components 220 is merely used as an exemplary description, and the present disclosure is not intended to limit the number, display positions, and specific forms of the additional content regions or the existing content region. For example, different additional content regions are displayed in the target interface 200A at the top and bottom of the component interaction region 215, respectively.

In some embodiments, with continued reference to FIG. 2A, the electronic device 110 may adjust display positions of the plurality of media components in the target interface 200A in response to a sliding operation for the target interface 200A. As an example, as shown in FIG. 2A, the electronic device 110 may adjust display positions of the plurality of media components in the target interface 200A based on the operation 211 for the target interface 200A. As an example, the electronic device 110 may move the plurality of media components in the sliding direction corresponding to the operation 211 based on the sliding distance of the operation 211 to adjust the display positions of the plurality of media components in the target interface 200A.

In some embodiments, with continued reference to FIG. 2A, the electronic device 110 may trigger a second media component in the plurality of media components to play the corresponding second media content, in response to the first display position of the second media component being adjusted to satisfy the first trigger condition. In some embodiments, the first trigger condition corresponds to a first column or a first row in which the second media component is located. Different columns or rows correspond to different trigger conditions.

In some embodiments, with continued reference to FIG. 2A, the first trigger condition may include a first boundary of the second media component reaching a predetermined position. The predetermined position may be determined based on the sliding direction of the sliding operation and the first column and/or the first row where the second media component is located.

In some embodiments, with continued reference to FIG. 2A, the first boundary is a boundary of an image region of the second media component. As an example, as shown in FIG. 2A, the boundary of the image region of the media component 205-2 may be the region indicated by the bold border in FIG. 2A. It should be noted that the bold border here is only for clearly illustrating the border of the image region, and in actual display, the border display styles of the media component 205-2 and other media components may be the same.

In some embodiments, with continued reference to FIG. 2A, the first boundary corresponds to the sliding direction. As an example, a boundary corresponding to a direction to which the sliding direction points is a first boundary. As an example, the sliding direction corresponding to operation 211 is the first direction. At this time, the first boundary of the media component 205-2 may be the upper boundary 206-1 in the boundary of the image region of the second media component.

Exemplary descriptions are given below with different trigger conditions corresponding to different columns.

In some embodiments, with continued reference to FIG. 2A, the media component 205-1 and media component 205-3 may be considered to be in column A. The media component 205-2 and media component 205-4 may be considered to be in column B.

As an example, with continued reference to FIG. 2A, a column A may be associated with a first predetermined position. The first predetermined position may be, for example, at a height where the trigger line A210-2 is located. As an example, as shown in FIG. 2A, the height H_{A} where the trigger line A210-2 is located may be determined based on the region size (e.g., the region height H₁) of the component interaction region 215 and/or the component size of the media component (e.g., the component height H₂). As an example, H_{A} may be determined based on the formula H_{A}=H₁−(H₂+H′). Where H′ is associated with the gap between the media components and/or between the media component and the top boundary of the component interaction region 215. The present disclosure is not intended to limit the specific value of H′.

As an example, with continued reference to FIG. 2A, the column B is associated with the second predetermined position. For example, the second predetermined position may be H_{B} where the trigger line B210-1 is located. As an example, as shown in FIG. 2A, the height H_{B} where the trigger line B210-1 is located may be determined based on the region size (e.g., the region height H₁) of the component interaction region 215 and/or the component size of the media component (e.g., the component height H₂). As an example, H_{B} may be determined based on the formula H_{B}=H_{A}+(H₂+H′)/2. (H₂+H′)/2 may represent a distance between the trigger line A210-2 and the trigger line B210-1.

In some embodiments, the electronic device 110 may adjust the above H_{A} and H_{B} based on the change of the region size (e.g., the region height H₁) and/or the component size of the media component (e.g., the component height H₂). The change of the region size and/or the component size of the media component may refer to description content of the change of the layout of the target interface, and details are not described herein again.

In some embodiments, with continued reference to FIG. 2A, after receiving the operation 211, the electronic device 110 may trigger the second media component to play the corresponding second media content in response to the first display position of the second media component being adjusted to satisfy the first trigger condition. As an example, after receiving the operation 211, the electronic device 110 triggers the media component 205-2 to play the corresponding media content in response to the upper boundary 206-1 of the media component 205 reaching the second predetermined position (exactly at or above the height H_{B} where the trigger line B210-1 is located) corresponding to the trigger line B210-1.

In some embodiments, with continued reference to FIG. 2C, the electronic device 110 may trigger the third media component to play the corresponding third media content in response to the second display position of the third media component in the plurality of media components being adjusted to satisfy the second trigger condition. The second trigger condition corresponds to a second column or a second row where the second media component is located.

As an example, as shown in FIG. 2C, the electronic device 110 may adjust a display position of the plurality of media components in the target interface 200C based on the operation 211. Further, the electronic device 110 may trigger the media component 205-3 to play the corresponding media content, in response to the second display position (e.g., the upper boundary 206-2 of the media component 205-3) of the third media component (e.g., the media component 205-3) being adjusted to satisfy the second condition (e.g., reaching the first predetermined position corresponding to the trigger line A210-2 (just at or above the height H_{A} where the trigger line A210-2 is located)). As an example, the media component 205-3 is in the column A (the column A is different from the column B in which media component 205-2 is located).

In some embodiments, with continued reference to FIG. 2C, when the upper boundary 206-2 of the media component 205-3 reaches the first predetermined position corresponding to the trigger line A210-2, the upper boundary 206-1 of the media component 205-2 is still at the second predetermined position corresponding to the trigger line B210-1. As an example, in this case, the media component that the electronic device 110 should trigger to play is determined as the media component 205-3 based on the sliding direction (for example, the first direction) corresponding to the operation 211. As an example, according to the first direction, the media component that is in a later position in the aforementioned Zigzag sorting may be determined to play the corresponding media content. For example, in the aforementioned Zigzag sorting, the media component 205-2 corresponds to a second order, the media component 205-3 corresponds to a third order, and the media component 205-3 in the third order can be preferentially triggered to play the corresponding media content based on the first direction.

In some embodiments, the electronic device 110 may trigger the second media component to stop playing the second media content in response to the second display position of the third media component being adjusted to satisfy the second trigger condition.

As an example, with continued reference to FIG. 2C, the electronic device 110 may trigger the media component 205-2 to stop playing the corresponding media content, in response to the upper boundary 206-2 of the media component 205 reaching the first predetermined position corresponding to the trigger line A210-2.

In some embodiments, with continued reference to FIG. 2C, the electronic device 110 may continue to adjust the display position of the plurality of media components based on the operation 211. In response to the upper boundary 206-3 of the media component 205 reaching the second predetermined position corresponding to the trigger line B210-1, the electronic device 110 may trigger the media component 205-4 to play the corresponding media content, and trigger the media component 205-3 to stop playing the corresponding media content.

In some embodiments, as shown in FIG. 2D, the electronic device 110 may continue to adjust the display positions of the plurality of media components based on the operation 211. The electronic device 110 may trigger the media component 205-4 to stop playing the corresponding media content, in response to the second boundary of the media component 205 reaching the predetermined position. The second boundary is opposite to the first boundary, that is, the second boundary and the first boundary may be respectively located on two sides of the boundary of the image region of the media component. As an example, the electronic device 110 may trigger the media component 205-4 to stop playing the corresponding media content, in response to the lower boundary 207-1 of the media component 205 reaching the second predetermined position corresponding to the trigger line B210-1 (just at or above the height H_{B} where the trigger line B210-1 is located).

In some embodiments, with continued reference to FIG. 2D, the electronic device 110 may present, in the target interface 200D, components 225 other than the media component. The electronic device 110 may determine an area displayed by the plurality of media components in a current display state of the target interface 200D, in response to none of the display positions of the plurality of media components in the target interface 200D satisfying a corresponding trigger condition. As an example, as shown in FIG. 2D, the media component 205-3 and the media component 205-5 in the target interface 200D do not satisfy the first predetermined position corresponding to the trigger line A210-2, and the media component 205-4 and the media component 205-6 do not satisfy the second predetermined position corresponding to the trigger line B210-1. Taking the media component 205-3 as an example, although the first boundary of the media component 205-3 is above the first predetermined position corresponding to the trigger line A210-2, the second boundary (i.e., the lower boundary 207-2) of the media component 205-3 is also above the first predetermined position corresponding to the trigger line A210-2. At this time, the display position of the media component 205-3 may be regarded as not satisfying the first predetermined position corresponding to the trigger line A210-2, which is similar for the media component 205-4.

In some embodiments, with continued reference to FIG. 2D, the area displayed by the media component 205-3 in the current display state of the target interface 200D may be S1, the area displayed by the media component 205-4 in the current display state of the target interface 200D may be S2, the area displayed by the media component 205-5 in the current display state of the target interface 200D may be S3, and the area displayed by the media component 205-6 in the current display state of the target interface 200D may be S4. As an example, S3=S4>S1=S2.

In some embodiments, with continued reference to FIG. 2D, the electronic device 110 may trigger the target media component in the plurality of media components to play the corresponding media content based on the areas displayed by the plurality of media components in the current display state of the target interface 200D.

In some embodiments, with continued reference to FIG. 2D, the electronic device 110 may determine a set of candidate media components based on sorting of the areas displayed by the plurality of media components in the current display state of the target interface 200D. As an example, the electronic device 110 may use the media component with the largest displayed area as the candidate media component. As an example, because S3=S4>S1=S2, a set of candidate media components may include a media playback component 205-5 and a media component 205-6.

In some embodiments, with continued reference to FIG. 2D, the electronic device 110 may determine the target media component to be triggered from the set of candidate media components based on the direction of the received additional sliding operation. As an example, as shown in FIG. 2D, the electronic device 110 may determine the target playback component from the set of candidate components based on the sliding direction (for example, the first direction) corresponding to the received operation 211. As an example, a media component that is in a higher order in the aforementioned Zigzag sorting may be determined to be preferably triggered to play the corresponding media content based on the first direction. For example, based on the Zigzag sorting, the position corresponding to media component 205-5 precedes the position corresponding to media component 205-6. Accordingly, the target media component may be the media component 205-5.

As an example, when the plurality of media components satisfies the trigger condition and no media component satisfies the trigger condition, the logic for the media component to be triggered is determined based on the Zigzag sorting by the sliding direction. For example, when the plurality of media components satisfies the trigger condition (for example, when the predetermined position is reached), it is determined, by using the first direction, that the media component at the back of the Zigzag sorting is the to-be-triggered media component. When none of the plurality of media components satisfy the trigger condition (for example, none of the plurality of media components reaches the predetermined position), the media component at the top of the Zigzag sorting is determined to be the to-be-triggered media component by using the first direction.

In some embodiments, as shown in FIG. 2E, the second media component may be associated with a plurality of media content. As an example, the electronic device 110 may present a media component 205-7 associated with multiple media content.

In some embodiments, with continued reference to FIG. 2E, the electronic device 110 may trigger the second media component to play the second media content in the plurality of media content based on a display order of the plurality of media content in the second media component. As an example, the electronic device 110 may trigger the media component 205-7 to play the media content 208 in the first display position among the plurality of media content based on a left-to-right display order of the plurality of media content in the media component 205-7.

### Example Two

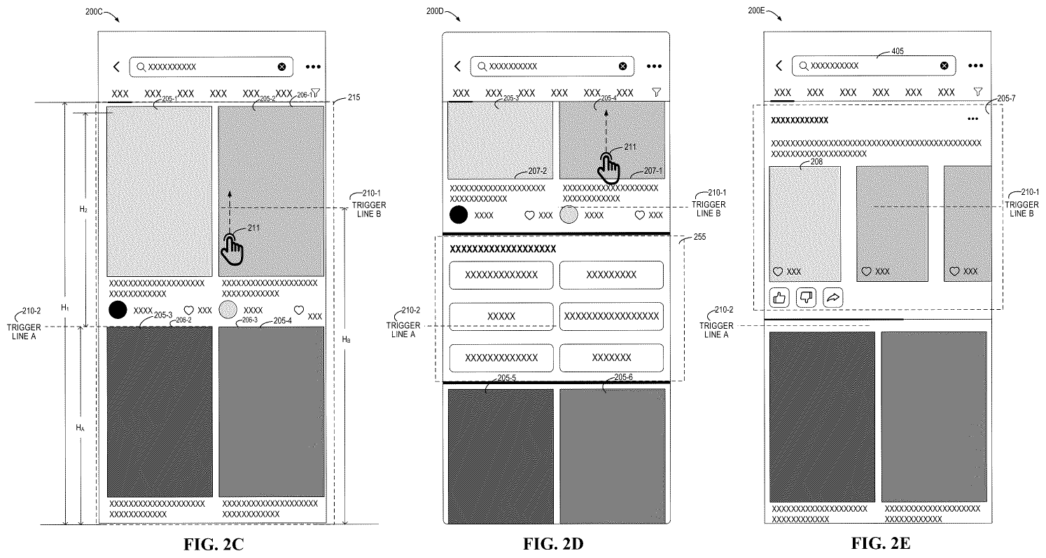

FIGS. 3A-3B illustrate example interfaces 300A-300B in accordance with some embodiments of the present disclosure. The interfaces 300A to 300B may be provided, for example, by the electronic device 110 shown in FIG. 1.

In some embodiments, as shown in FIG. 3A, the electronic device 110 may present the target interface 300A. The electronic device 110 may present a plurality of media components in the target interface 300A. For example, the plurality of media components may include a media component 305-1, a media component 305-2, a media component 305-3, a media component 305-4, and/or the like. As an example, a media component may be used to play media content.

In some embodiments, with continued reference to FIG. 3A, the electronic device 110 may present the plurality of media components in a target style. The target style indicates a layout of at least a portion of the plurality of media components in a plurality of rows or columns.

In some embodiments, with continued reference to FIG. 3A, the electronic device 110 triggers the first media component of the plurality of media components to play the corresponding first media content. As an example, the electronic device 110 may trigger the first media content corresponding to the first media component (e.g., the media component 305-1).

In some embodiments, with continued reference to FIG. 3A, the electronic device 110 may determine the first media component based on the sorting of the plurality of media components in the target interface, in response to the target interface 300A being triggered to be presented. As an example, the sorting of the plurality of media components in the target interface may be arranged in a zigzag order (e.g., left-to-right order within the same row and top-to-bottom order between rows). For example, the media component 305-1 and the media component 305-2 in the first row may correspond to a first order and a second order, respectively. The media component 305-3 and the media component 305-4 in the second row may correspond to the third order and the fourth order, respectively. As an example, the electronic device 110 may determine the media component at the top of the sorting as the first media component (e.g., the media component 305-1 in the first position) based on the sorting of the multiple media components in the target interface.

In some embodiments, with continued reference to FIG. 3A, the electronic device 110 may provide a component interaction region 315 (also referred to as a sliding region 315) in the target interface. The electronic device 110 may present a plurality of media components in the component interaction region 315. Further, the electronic device 110 may receive a sliding operation from the user in the component interaction region 315.

In some embodiments, with continued reference to FIG. 3A, the region size of the component interaction region 315 may include a region height and a region width. The region height may, for example, be referred to as a region length. The region height may be, for example, H₃. The region height H₃ may indicate a sliding distance limit in the second direction (e.g., the direction indicated by operation 311). The region width may indicate a sliding distance limit perpendicular to the first direction.

In some embodiments, with continued reference to FIG. 3A, the electronic device 110 may adjust display positions of the plurality of media components in the target interface 300A, in response to a sliding operation for the target interface 300A. As an example, as shown in FIG. 3A, the electronic device 110 may adjust a display position of the plurality of media components in the target interface 300A based on the operation 311 for the target interface 300A. As an example, the electronic device 110 may move the plurality of media components in the sliding direction corresponding to the operation 311 based on the sliding distance of the operation 311, to adjust the display positions of the plurality of media components in the target interface 300A.

In some embodiments, with continued reference to FIG. 3A, the electronic device 110 may trigger the second media component to play the corresponding second media content, in response to the first display position of the second media component in the plurality of media components being adjusted to satisfy the first trigger condition. In some embodiments, the first trigger condition corresponds to a first column or a first row in which the second media component is located. Different columns or rows correspond to different trigger conditions.

In some embodiments, with continued reference to FIG. 3A, the first trigger condition may include a first boundary of the second media component reaching a predetermined position. The predetermined position may be determined based on the sliding direction of the sliding operation and the first column and/or the first row where the second media component is located.

In some embodiments, with continued reference to FIG. 3A, the first boundary is a boundary of an image region of the second media component. As an example, as shown in FIG. 3A, the boundary of the image region of the media component 305-2 may be the region indicated by the bold border in FIG. 3A. It should be noted that the bold border here is only for clearly illustrating the border of the image region, and in actual display, border display styles for the media component 305-2 and other media components may be the same.

In some embodiments, with continued reference to FIG. 3A, the first boundary corresponds to the sliding direction. As an example, a boundary corresponding to a direction to which the sliding direction points is the first boundary. As an example, the sliding direction corresponding to operation 311 is the second direction. At this time, the first boundary of the media component 305-2 may be the lower boundary 306-2 in boundaries of the image region of the second media component.

Exemplary descriptions are given below with different trigger conditions corresponding to different columns.

In some embodiments, with continued reference to FIG. 3A, the media component 305-1 and the media component 305-3 may be considered to be in column C. The media component 205-2 and the media component 205-4 may be considered to be in column D.

As an example, with continued reference to FIG. 2A, the column C may be associated with the first predetermined position. The first predetermined position may be, for example, at a height where the trigger line C310-1 is located. As an example, as shown in FIG. 3A, the height H_{C} where the trigger line C310-1 is located may be determined based on the region size of the component interaction region 315 (e.g., the region height H₃) and/or the component size of the media component (e.g., the component height H₄ and the image region height H₅ of the media component). As an example, H_{C} may be determined based on the formula H_{C}=H₃−(H₄+H′)/2−H₅. Where H′ is associated with the gap between the media components and/or between the media component and the top boundary of the component interaction region 315. The present disclosure is not intended to limit the specific value of H′. (H₄+H′)/2 may represent the distance between the trigger line C310-1 and the trigger line D310-2.

As an example, with continued reference to FIG. 3A, the column D is associated with the second predetermined position. For example, the second predetermined position may be H_{D} where the trigger line D310-2 is located. As an example, as shown in FIG. 3A, the height Hp where the trigger line D310-2 is located may be determined based on the region size of the component interaction region 315 (e.g., the region height H₃) and/or the component size of the media component (e.g., the image region height H₅ of the media component). As an example, H_{D} may be determined based on the formula H_{D}=H₃−(H₅+H′).

In some embodiments, with continued reference to FIG. 3A, after receiving the operation 311, the electronic device 110 may trigger the second media component to play the corresponding second media content, in response to the first display position of the second media component being adjusted to satisfy the first trigger condition. As an example, after receiving the operation 311, the electronic device 110 triggers the media component 305-3 to play the corresponding media content, in response to the lower boundary 306-3 of the media component 305 reaching the first predetermined position (just at or below the height He where the trigger line C310-1 is) corresponding to the trigger line C310-1.

In some embodiments, with continued reference to FIG. 3B, the electronic device 110 may trigger the third media component to play the corresponding third media content, in response to the second display position of the third media component of the plurality of media components being adjusted to satisfy the second trigger condition. The second trigger condition corresponds to a second column or a second row where the second media component is located.

As an example, as shown in FIG. 3B, the electronic device 110 may adjust display positions of the plurality of media components in the target interface 300B based on the operation 311. Further, the electronic device 110 may trigger the media component 305-2 to play the corresponding media content, in response to the second display position (e.g. the lower boundary 306-2 of the media component 305-2) of the third media component (e.g., the media component 305-2) being adjusted to satisfy the second condition (e.g., reaching the second predetermined position corresponding to the trigger line D310-2 (just at or below the height Hp where the trigger line D310-2 is located). As an example, the media component 305-2 is in column D (the column D is different from the column C in which the media component 305-3 is located).

In some embodiments, with continued reference to FIG. 3B, when the lower boundary 306-2 of the media component 305-2 reaches the second predetermined position corresponding to the trigger line D310-2, the lower boundary 306-3 of the media component 305-3 is still at the first predetermined position corresponding to the trigger line C310-1. As an example, in this case, the media component that the electronic device 110 should trigger to play is determined as the media component 305-3 based on the sliding direction (for example, the second direction) corresponding to the operation 311. As an example, the media component at the top of the aforementioned Zigzag sorting may be determined to be preferentially triggered to play the corresponding media content, based on the second direction. For example, in the aforementioned Zigzag sorting, the media component 305-2 corresponds to the second order, the media component 305-3 corresponds to the third order, and the media component 305-2 in the second order can be preferentially triggered to play the corresponding media content based on the second direction.

In some embodiments, the electronic device 110 may trigger the second media component to stop playing the second media content in response to the second display position of the third media component being adjusted to satisfy the second trigger condition.

As an example, with continued reference to FIG. 3B, the electronic device 110 may trigger the media component 305-3 to stop playing the corresponding media content in response to the lower boundary 306-2 of the media component 305-2 reaching the second predetermined position corresponding to the trigger line D310-2.

In some embodiments, with continued reference to FIG. 3B, the electronic device 110 may continue to adjust the display positions of the plurality of media components based on the operation 311. The electronic device 110 may trigger the media component 305-1 to play the corresponding media content, in response to the lower boundary 306-1 of the media component 305-1 reaching the first predetermined position corresponding to the trigger line C310-1, and trigger the media component 305-2 to stop playing the corresponding media content.

Based on the processes described above, the embodiments of the present disclosure can determine or adjust different predetermined positions for triggering media components to play media content based on component interaction region, media components, and other components in the target interface and based on different sliding directions. Moreover, the embodiments of the present disclosure may adjust a position of a media component based on the sliding operation of the user, and may determine, according to the position of the media component, whether the trigger condition corresponding to the row or column where the media component is located is satisfied, to trigger the corresponding play component to play the corresponding media content. In this way, the embodiments of the present disclosure can dynamically switch the preview of the media content in the interface according to the display position and the sliding direction of the media component in the display interface of the multiple media content, thereby improving the display efficiency of the media content.

### Example Processes

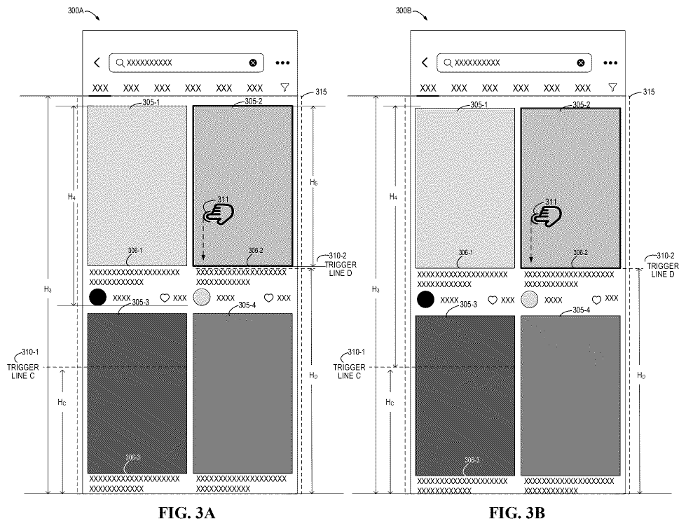

FIG. 4 illustrates a flowchart of an example process 400 for interface interaction in accordance with some embodiments of the present disclosure. The process 400 may be implemented at electronic device 110. The process 400 is described below with reference to FIG. 1.

As shown, at block 410, the electronic device 110 presents a plurality of media components in a target style in a target interface, the target style indicating a layout of at least a portion of the plurality of media components in a plurality of columns or rows.

At block 420, the electronic device 110 triggers a first media component in the plurality of media components to play corresponding first media content.

At block 430, the electronic device 110 adjusts, in response to a sliding operation for the target interface, display positions of the plurality of media components in the target interface.

At block 440, the electronic device 110 triggers, in response to a first display position of a second media component in the plurality of media components being adjusted to satisfy a first trigger condition, the second media component to play corresponding second media content, where the first trigger condition corresponds to a column or row in which the second media component is located, and different columns or rows correspond to different trigger conditions.

In some embodiments, the first trigger condition includes: a first boundary of the second media component reaching a predetermined position, where the predetermined position is determined based on a sliding direction of the sliding operation and a first column and/or a first row where the second media component is located, and the first boundary corresponds to the sliding direction.

In some embodiments, the predetermined position is further determined based on a region size of a component interaction region in the target interface and/or a component size of a media component.

In some embodiments, the process 400 further includes: in response to a change in a layout of the target interface, determining an updated region size of the component interaction region; and adjusting the predetermined position based on the updated region size.

In some embodiments, the change in the layout of the target interface includes: displaying an additional content region in the target interface; and/or stopping displaying an existing content region in the target interface.

In some embodiments, the process 400 further includes: in response to a second boundary of the second media component reaching the predetermined position, triggering the second media component to stop playing the second media content, where the second boundary is opposite to the first boundary.

In some embodiments, the first boundary and/or the second boundary are boundaries of an image region of the second media component.

In some embodiments, the process 400 further includes: in response to a second display position of a third media component in the plurality of media components being adjusted to satisfy a second trigger condition, triggering the third media component to play corresponding third media content, where the second trigger condition corresponds to a second column or a second row in which the second media component is located.

In some embodiments, the second column is different from the first column, or the second row is different from the first row.

In some embodiments, the process 400 further includes: in response to the second display position of the third media component being adjusted to satisfy the second trigger condition, triggering the second media component to stop playing the second media content.

In some embodiments, the process 400 further includes: in response to the target interface being triggered to be presented, determining the first media component based on rank of the plurality of media components in the target interface.

In some embodiments, the process 400 further includes: determining, in response to none of display positions of the plurality of media components in the target interface satisfying a corresponding trigger condition, areas displayed by the plurality of media components in a current display state of the target interface; and triggering a target media component of the plurality of media components to play corresponding media content based on the displayed areas.

In some embodiments, the process 400 further includes: determining a set of candidate media components based on sorting of the displayed areas; and determining the target media component to be triggered from the set of candidate components based on a direction of a received additional sliding operation.

In some embodiments, the second media component is associated with a plurality of media content, and triggering the second media component to play the corresponding second media content includes: triggering, based on a display order of the plurality of media content in the second media component, the second media component to play the second media content in the plurality of media content.

### Example Apparatus and Device

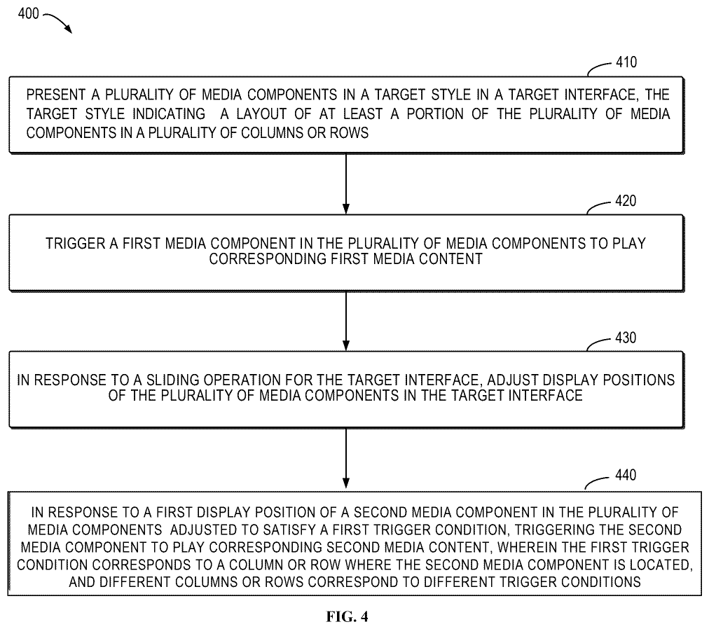

Embodiments of the present disclosure also provide a corresponding apparatus for implementing the above method or process. FIG. 5 shows a schematic structural block diagram of an example apparatus 500 for interface interaction according to some embodiments of the present disclosure. The apparatus 500 may be implemented as or included in an electronic device. The various modules/components in the apparatus 500 may be implemented by hardware, software, firmware, or any combination thereof.

As shown in FIG. 5, the apparatus 500 includes a presentation module 510 configured to present a plurality of media components in a target style in a target interface, the target style indicating a layout of at least a portion of the plurality of media components in a plurality of columns or rows; a first trigger module 520 configured to trigger a first media component in the plurality of media components to play corresponding first media content; an adjustment module 530 configured to, in response to a sliding operation for the target interface, adjust display positions of the plurality of media components in the target interface; and a second trigger module 540 configured to, in response to a first display position of a second media component in the plurality of media components adjusted to satisfy a first trigger condition, trigger the second media component to play corresponding second media content, wherein the first trigger condition corresponds to a column or row where the second media component is located, and different columns or rows correspond to different trigger conditions.

In some embodiments, the first trigger condition includes: a first boundary of the second media component reaching a predetermined position, where the predetermined position is determined based on a sliding direction of the sliding operation and a first column and/or a first row where the second media component is located, and the first boundary corresponds to the sliding direction.

In some embodiments, the predetermined position is further determined based on a region size of a component interaction region in the target interface and/or a component size of a media component.

In some embodiments, the apparatus 500 further includes an updating module configured to: determine, in response to a change in a layout of the target interface, an updated region size of the component interaction region; and adjust the predetermined position based on the updated region size.

In some embodiments, the change in the layout of the target interface includes: displaying an additional content region in the target interface; and/or stopping displaying an existing content region in the target interface.

In some embodiments, the apparatus 500 further includes a first stopping module configured to, in response to a second boundary of the second media component reaching the predetermined position, trigger the second media component to stop playing the second media content, where the second boundary is opposite to the first boundary.

In some embodiments, the first boundary and/or the second boundary are boundaries of an image region of the second media component.

In some embodiments, the apparatus 500 further includes a third trigger module configured to, in response to a second display position of a third media component in the plurality of media components adjusted to satisfy a second trigger condition, trigger the third media component to play corresponding third media content, wherein the second trigger condition corresponds to a second column or a second row where the second media component is located.

In some embodiments, the second column is different from the first column, or the second row is different from the first row.

In some embodiments, the apparatus 500 further includes a second stopping module configured to, in response to the second display position of the third media component adjusted to satisfy the second trigger condition, trigger the second media component to stop playing the second media content.

In some embodiments, the apparatus 500 further includes a first determination module configured to, in response to the target interface being triggered to be presented, determine the first media component based on rank of the plurality of media components in the target interface.

In some embodiments, the apparatus 500 further includes a processing module configured to, in response to none of display positions of the plurality of media components in the target interface satisfying a corresponding trigger condition, determine areas displayed by the plurality of media components in a current display state of the target interface; and trigger a target media component of the plurality of media components to play corresponding media content based on the displayed areas.

In some embodiments, the apparatus 500 further includes a second determination module configured to: determine a set of candidate media components based on sorting of the displayed areas; and determine a target media component to be triggered from the set of candidate components based on a direction of a received additional sliding operation.

In some embodiments, the second media component is associated with a plurality of media content, and the second trigger module 540 is further configured to, based on a display order of the plurality of media content in the second media component, trigger the second media component to play the second media content in the plurality of media content.

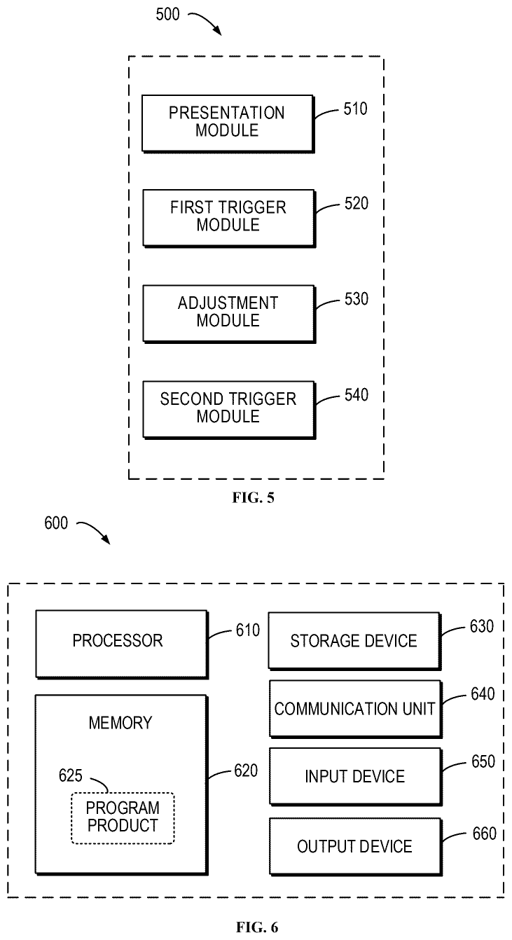

FIG. 6 illustrates a block diagram of an electronic device 600 in which one or more embodiments of the present disclosure may be implemented. It should be understood that the electronic device 600 illustrated in FIG. 6 is merely exemplary and should not constitute any limitation on the functionality and scope of the embodiments described herein. The electronic device 600 shown in FIG. 6 may be used as an electronic device.

As shown in FIG. 6, the electronic device 600 is in the form of a general-purpose electronic device. Components of the electronic device 600 may include, but are not limited to, one or more processors or processing units 610, a memory 620, a storage device 630, one or more communications units 640, one or more input devices 650, and one or more output devices 660. The processing unit 610 may be an actual or virtual processor and can perform various processes according to programs stored in the memory 620. In a multiprocessor system, a plurality of processing units executes computer executable instructions in parallel, so as to improve the parallel processing capability of the electronic device 600.

The electronic device 600 typically includes a number of computer storage media. Such media may be any available media that are accessible by electronic device 600, including, but not limited to, volatile and non-volatile media, removable and non-removable media. The memory 620 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 630 may be a removable or non-removable medium and may include a machine-readable medium such as a flash drive, a magnetic disk, or any other medium that can be used to store information and/or data and that can be accessed within the electronic device 600.

The electronic device 600 may further include additional removable/non-removable, volatile/nonvolatile storage media. Although not shown in FIG. 6, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 620 may include a computer program product 625 having one or more program modules configured to perform various methods or actions of various embodiments of the present disclosure.

The communication unit 640 implements communication with other electronic devices through a communication medium. In addition, functions of components of the electronic device 600 may be implemented by a single computing cluster or a plurality of computing machines, and these computing machines can communicate through a communication connection. Thus, the electronic device 600 may operate in a networked environment using logical connections to one or more other servers, network personal computers (PCs), or another network node.

The input device 650 may be one or more input devices such as a mouse, keyboard, trackball, etc. The output device 660 may be one or more output devices such as a display, speaker, printer, etc. The electronic device 600 may also communicate with one or more external devices (not shown) such as a storage device, a display device, or the like through the communication unit 640 as required, and communicate with one or more devices that enable a user to interact with the electronic device 600, or communicate with any device (e.g., a network card, a modem, or the like) that enables the electronic device 600 to communicate with one or more other electronic devices. Such communication may be performed via an input/output (I/O) interface (not shown).

According to an exemplary implementation of the present disclosure, a computer readable storage medium is provided, on which a computer-executable instruction is stored, where the computer executable instruction is executed by a processor to implement the above-described method. According to an exemplary implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when being executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods, and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein.

I/We claim:

1. A method for interface interaction, comprising:
presenting a plurality of media components in a target style in a target interface, the target style indicating a layout of at least a portion of the plurality of media components in a plurality of columns or rows;
triggering a first media component in the plurality of media components to play corresponding first media content;
in response to a slide on the target interface, adjusting display positions of the plurality of media components in the target interface; and
in response to a first display position of a second media component in the plurality of media components adjusted to satisfy a first trigger condition, triggering the second media component to play corresponding second media content, wherein the first trigger condition corresponds to a column or row where the second media component is located, and different columns or rows correspond to different trigger conditions.

2. The method of claim 1, wherein the first trigger condition comprises:
a first boundary of the second media component reaches a predetermined position, wherein the predetermined position is determined based on a sliding direction of the slide and a first column and/or a first row where the second media component is located, and the first boundary corresponds to the sliding direction.

3. The method of claim 2, wherein the predetermined position is further determined based on a region size of a component interaction region in the target interface and/or a component size of a media component.

4. The method of claim 3, further comprising:
in response to a change in a layout of the target interface, determining an updated region size of the component interaction region; and
adjusting the predetermined position based on the updated region size.

5. The method of claim 4, wherein the change in the layout of the target interface comprises:
displaying an additional content region in the target interface; and/or
stopping displaying an existing content region in the target interface.

6. The method of claim 2, further comprising:
in response to a second boundary of the second media component reaching the predetermined position, triggering the second media component to stop playing the second media content, wherein the second boundary is opposite to the first boundary.

7. The method of claim 6, wherein the first boundary and/or the second boundary are boundaries of an image region of the second media component.

8. The method of claim 1, further comprising:
in response to a second display position of a third media component in the plurality of media components adjusted to satisfy a second trigger condition, triggering the third media component to play corresponding third media content, wherein the second trigger condition corresponds to a second column or a second row where the second media component is located.

9. The method of claim 8, wherein the second column is different from the first column, or the second row is different from the first row.

10. The method of claim 8, further comprising:
in response to the second display position of the third media component adjusted to satisfy the second trigger condition, triggering the second media component to stop playing the second media content.

11. The method of claim 1, further comprising:
in response to the target interface triggered to be presented, determining the first media component based on rank of the plurality of media components in the target interface.

12. The method of claim 1, further comprising:
in response to none of display positions of the plurality of media components in the target interface satisfying a corresponding trigger condition, determining areas displayed by the plurality of media components in a current display state in the target interface; and
triggering a target media component in the plurality of media components to play corresponding media content based on the displayed areas.

13. The method of claim 12, further comprising:
determining a set of candidate media components based on rank of the displayed areas; and
determining the target media component to be triggered from the set of candidate components based on a direction of an additional slide.

14. The method of claim 1, wherein the second media component is associated with a plurality of media content, and triggering the second media component to play the corresponding second media content comprises:
triggering, based on a display order of the plurality of media content in the second media component, the second media component to play the second media content in the plurality of media content.

15. An electronic device, comprises:
at least one processor; and
at least one memory coupled to the at least one processor and storing instructions for execution by the at least one processor, the instructions, when executed by the at least one processor, causing the electronic device to perform acts comprising:
presenting a plurality of media components in a target style in a target interface, the target style indicating a layout of at least a portion of the plurality of media components in a plurality of columns or rows;
triggering a first media component in the plurality of media components to play corresponding first media content;
in response to a slide on the target interface, adjusting display positions of the plurality of media components in the target interface; and
in response to a first display position of a second media component in the plurality of media components adjusted to satisfy a first trigger condition, triggering the second media component to play corresponding second media content, wherein the first trigger condition corresponds to a column or row where the second media component is located, and different columns or rows correspond to different trigger conditions.

16. The electronic device of claim 15, wherein the first trigger condition comprises:
a first boundary of the second media component reaches a predetermined position, wherein the predetermined position is determined based on a sliding direction of the slide and a first column and/or a first row where the second media component is located, and the first boundary corresponds to the sliding direction.

17. The electronic device of claim 16, wherein the predetermined position is further determined based on a region size of a component interaction region in the target interface and/or a component size of a media component.

18. The electronic device of claim 17, the acts further comprise:
in response to a change in a layout of the target interface, determining an updated region size of the component interaction region; and
adjusting the predetermined position based on the updated region size.

19. The electronic device of claim 18, wherein the change in the layout of the target interface comprises:
displaying an additional content region in the target interface; and/or
stopping displaying an existing content region in the target interface.

20. A computer-readable storage medium having stored thereon a computer program that, when executed by a processor, implements a method comprising:
presenting a plurality of media components in a target style in a target interface, the target style indicating a layout of at least a portion of the plurality of media components in a plurality of columns or rows;
triggering a first media component in the plurality of media components to play corresponding first media content;
in response to a slide on the target interface, adjusting display positions of the plurality of media components in the target interface; and
in response to a first display position of a second media component in the plurality of media components adjusted to satisfy a first trigger condition, triggering the second media component to play corresponding second media content, wherein the first trigger condition corresponds to a column or row where the second media component is located, and different columns or rows correspond to different trigger conditions.
